(19) United States
(12) Patent Application Publication
(10) Pub. No.: US 2006/0146055 A1
(43) Pub. Date: Jul. 6, 2006

(54) Graphics controller providing for animated windows

(76) Inventors: Raymond Chow, Richmond (CA); Jimmy Kwok Lap Lai, Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/031,934

(22) Filed: Jan. 6, 2005

(51) Int. Cl. G06T 15/70

(52) U.S. Cl. 345/473

(57) ABSTRACT

A graphics controller providing for animated windows. A circuit in the graphics controller is adapted for receiving an instruction from a host specifying an evolution of an animated window. The circuit automatically animates the window in response to the instruction.

### FIELD OF THE INVENTION

The invention relates to a graphics controller providing for animated windows, particularly for use in battery-powered, portable appliances such as mobile telephones.

### BACKGROUND

In a graphics display device, such as a liquid crystal display (“LCD”), data for display as well as instructions for displaying the data are provided by a host. In principle, any host or central processing unit (“CPU”) can interface directly with a display device provided that the host's read/write operations conform to the protocol specified for the display device. However, this is usually not efficient and a graphics controller is frequently provided as an interface between the host and the display device. Such a graphics controller is typically a separate, dedicated integrated circuit (“IC”), such as an LCD controller, which provides specialized functions related to driving the panel.

An example of such a graphics controller is an LCD controller used in a mobile telephone. The telephone includes a host such as a microprocessor or digital signal processor, a camera, a system memory, one or more LCD panels, as well as other components. The LCD controller provides a camera interface for receiving image data from the camera, and circuitry for converting the image data into a displayable form and transmitting the data to the panel or elsewhere. Image data is often organized into frames that comprise rectangular arrays of pixels, and LCD controllers often have their own internal memory for storing frames, commonly referred to as a “frame buffer.” The controller typically includes a JPEG encoder/decoder (“CODEC”) for encoding outgoing image data for transmission and decoding incoming image data for display. The controller typically provides other functions as well, such as cropping or otherwise resizing images, and translating image data from one color space to another. In telephone and other systems used for data communications, such controllers are used for both wireless and wired communications.

In the mobile telephone example given above, both the host and the camera generally provide graphics data to the LCD panel(s) for display. In addition, the host issues commands to the LCD panel(s) to enable the selected LCD panel(s) and to specify display parameters, such as image size and color resolution.

Mobile consumer-oriented systems, particularly mobile telephones, are frequently being provided with new capabilities driven by consumer demand. For example, designers increasingly wish to incorporate into battery-powered, portable appliances display effects and features that mimic those provided in desktop personal computers (“PC's”). However, unlike the PC, the designs for battery-powered appliances must optimally manage the system's scarce resources. Memory is typically limited and power conservation is critical. In order to conserve power, CPU cycles, and bus and memory usage must be minimized. Moreover, in mobile telephones, because the host must meet the substantial processing demands associated with handling calls, there is a need to minimize the number of interrupt requests (“IRQs”) that other devices send the host, especially those of a time sensitive nature.

One popular feature found in the PC is a windows type of user interface. PC's using a windows-type operating system provide for main windows and one or more sub-windows (“window(s)”), common examples of the latter being pop-up windows, dialog boxes, and pull-down menus. Often a window is caused to appear or disappear. virtually instantaneously. However, window transitions may be more pleasing when the window changes size or position at a rate that renders the change perceivable as animation. Accordingly, the transitions of such an “animated window” have also been provided on PC's having the resources to implement them.

This type of transition of an animated window has also been provided in mobile telephone systems. The transition of the animated window may be provided in such a system by causing the host to specify the evolution of the animated window, i.e., how the window changes in size or location as a function of time. The host specifies the evolution of the animated window by developing a sequence of frames of image data (“window frames”), wherein each window frame defines the window at a particular time. The host develops the evolving sequence of window frames in the system memory without assistance from the LCD controller. The host writes the window frames, pixel by pixel, from the system memory to the frame buffer in the LCD controller for ultimate display. In the mobile telephone example given above, the host is typically coupled to the LCD controller via an indirect or a serial bus interface and the window frames are transferred over such a bus. However, both bus types are relatively slow, which is typically undesirable from a timing point of view as it is generally necessary to refresh the panel at specific periodic intervals, such as with a 60 Hz display refresh rate. Moreover, sending an entire new window frame to the frame buffer for each sequential window frame has the disadvantage of requiring a significant amount of bus and system memory bandwidth.

Another disadvantage of having the host provide the transition of the animated window is that the LCD controller typically generates an interrupt request each time a display refresh cycle is complete, e.g., each time a “VYSNC” signal is generated a corresponding IRQ is sent to the host. The evolution of the animated window is a function of time, but the sequence of window frames does not typically evolve at the same rate as the display refresh rate. For instance, the sequence of window frames may evolve at one-tenth the display refresh rate, or 6 Hz in the above example, in order for the animated window to be visually perceptible. Thus, when the host receives the IRQ it must first determine whether it is time to send the next sequential window frame. Depending on the timing, the host either (a) increments a counter and clears the IRQ, or (b) sends the next sequential window frame to the LCD controller, resets the counter, and clears the IRQ. In either case, the host receives IRQs at the display refresh rate. Further, it must handle the IRQ more or less immediately because the LCD controller needs a response before the next display refresh cycle begins. This is undesirable as it is being maximally demanding on the host, requiring substantial numbers of CPU cycles and degrading overall system performance.

It would be desirable to provide battery-powered, portable appliances, such as mobile telephones with animated window transitions without consuming the power or CPU cycles required of a desktop PC and in a way which minimizes the number of interrupt requests sent to the host. Accordingly, there is a need for a graphics controller providing for animated windows that provides savings in power consumption as well as other advantages, particularly for use in battery-powered, portable appliances.

### SUMMARY

According to the invention, a graphics controller providing for animated windows is disclosed for interfacing between a host and a graphics display device having an associated display area. A circuit in the graphics controller is adapted for receiving an instruction from the host specifying an evolution of an animated window. The circuit automatically animates the window in response to the instruction.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a block diagram of a system according to the present invention comprising a host, a graphics controller, and a graphics display device, such as for use in a cell phone.

FIG. 2 is a pictorial view of the display area of a display device showing a main window and a sub-window along with an exemplary evolution of the sub-window.

FIG. 3A shows a sequence of window frames providing an example of the evolution of a window, showing a sub-window size transition.

FIG. 3B shows a sequence of window frames providing another example of the evolution of a window, showing a pull-down menu transition.

FIG. 3C shows a sequence of window frames providing yet another example of the evolution of a window, showing a wiper effect transition.

FIG. 4 is a schematic view of an animate circuit according to the present invention.

### DETAILED DESCRIPTION OF PREFERRED EMBODIMENTS

The invention is directed to a graphics controller providing for animated windows, particularly for use in battery-powered, portable appliances such as mobile telephones. Reference will now be made in detail to the present preferred embodiments of the invention, examples of which are illustrated in the accompanying drawings. Wherever possible, the same reference numbers are used in the drawings and the description to refer to the same or like parts.

In a battery-powered, portable appliance, a graphics controller may be provided with a BitBLT (“bit-block transfer”) engine for facilitating the transition of an animated window. A BitBLT engine is hardware which accepts instructions from the host to transfer particular blocks of pixels from one memory location to another. The BitBLT engine is capable of transferring a block of pixels from a non-display region to a display region (frame buffer) of the graphic controller's internal memory (or vice versa). In operation, the host sends new instructions for creating a new window frame to the BitBLT engine at a rate that is significantly reduced from the frame rate at which the graphics controller refreshes the display panel thereby providing perceivable animation. The graphics controller sends the host an IRQ at the end of each display refresh cycle and the host sends a new instruction to the BitBLT at the desired frequency. This technique has the advantage of relieving the host from having to specify the evolution of an animated window by sending an entire new frame for each sequential window frame. However, the host still receives the same number of time sensitive interrupt requests from the graphics controller. Further, this technique requires a significant amount of the graphic controller's internal memory, which is a scarce resource.

Alternatively, in a battery-powered portable appliance, the graphics controller may be provided with select logic, such as a multiplexer, for selectively fetching pixels from two regions of its internal memory for facilitating the transition of an animated window. In operation, the host writes a full frame of data corresponding to a main window to a main window region of internal memory. In addition, the host writes a full frame of data corresponding to a sub-window to a sub-window region of memory. At the end of each display refresh cycle, the graphics controller sends the host an IRQ and the host instructs the select logic to produce the desired sequence of window frames. The instruction the host sends to the multiplexer causes it to select data from either the main window or sub-window region of memory. In addition, the instruction specifies how the dimensions of the sub-window are to be adjusted for every animation interval. This technique has the advantage of relieving the host from having to specify the evolution of an animated window by sending an entire new frame for each sequential window frame. However, the host still receives the same number of time sensitive interrupt requests from the graphics controller and is required to calculate adjusted sub-window dimensions for each animation interval.

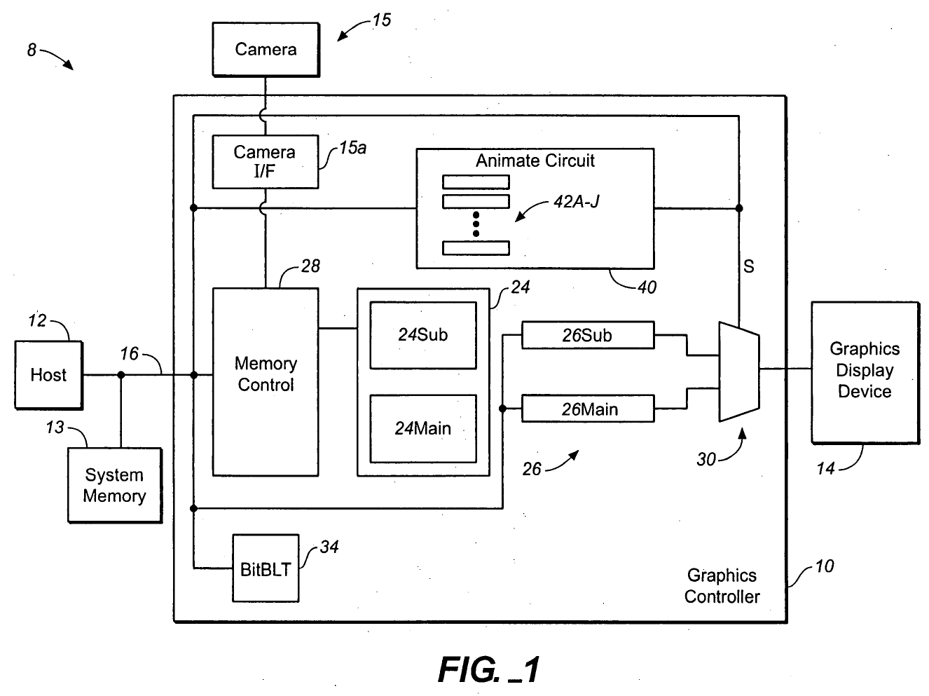

Referring to FIG. 1, a system 8 including a graphics controller 10 according to the invention is shown. The system 8 may be any digital system or appliance providing graphics output, but the graphics controller 10 is particularly advantageous for use in a portable appliance that is powered by a battery (not shown), where reduced power consumption is particularly important. The preferred system 8 is a mobile telephone.

The system 8 includes a standard host 12 and graphics display device 14, and the graphics controller interfaces between the host and the display device. The graphics controller is typically and preferably a single IC separate from the host and separate from the display device 14.

The host 12 is preferably a microprocessor, but may be a computer or any other provider of image data. The host 12 has an associated system memory 13.

The system also typically, though not necessarily, includes an asynchronous video source such as a camera module 15, which also provides image data to the graphics controller 10. The camera module 15 is commonly coupled to the graphics controller 10 through a (built-in) camera interface 15a.

The graphics controller 10 interfaces with the host 12 and the camera 15. The graphics controller receives data and instructions from the host over a bus 16, and receives data from the camera over the interface 15a. The bus 16 may be serial or parallel, and may be organized to transmit the data and instructions over the same line(s) or over separate line(s) of the bus.

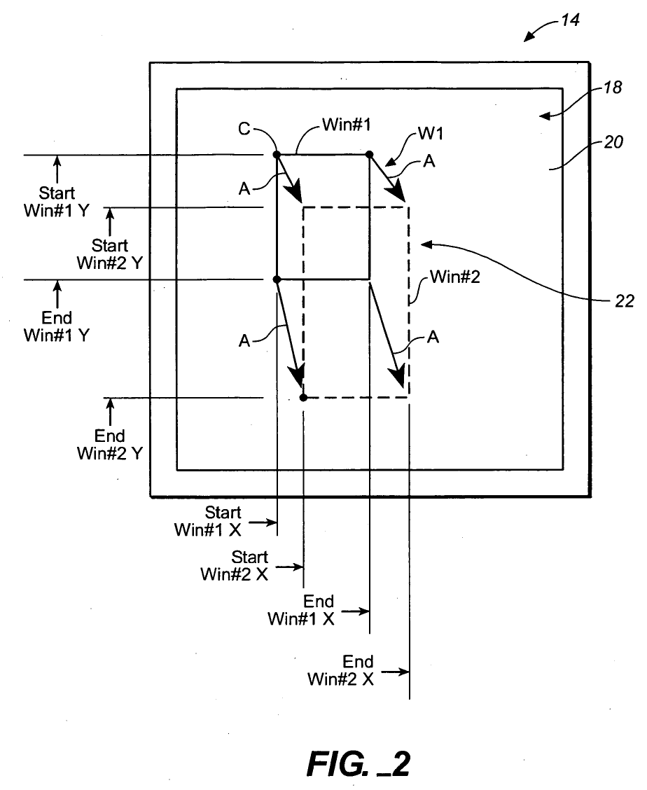

FIG. 2 shows the graphics display device 14 in greater detail. The graphics display device 14 is adapted for displaying pixels of image data on a display area 18 of the device. LCDs are typically used as display devices in mobile telephones, but any device(s) capable of rendering pixel data in visually perceivable form may be employed. The pixels originate from the host 12 (or camera 15) and are transmitted to the display device through the graphics controller 10.

Referring to FIG. 2, image data may be displayed on the display device 14 within windows, each window defining, typically, a rectangular area within the display area 18. Image data corresponding to a window populate the window. There may be and often are more image data corresponding to a window than can be seen in the window. Often the system provides for displaying image data corresponding to a larger main window 20 within which may be displayed image data corresponding to a smaller sub-window 22. Usually, the main window dimensions are fixed and it is desired to change the size of, and therefore to animate, the sub-window, and this context will be assumed for illustrative purposes. However, it should be understood that any window may be animated according to the invention. It should also be understood that animation of any number of windows or sub-windows may be supported by the graphics controller.

Referring back to FIG. 1, the graphics controller 10 includes an internal memory 24 for storing the image data. Typically, the memory 24 includes a storage region 24main for storing image data corresponding to a main window and a storage region 24sub for storing image data corresponding to a sub-window. A memory controller 28 accepts image data from a source, e.g., the host 12 or camera 15, and writes the data into the appropriate storage area of the memory 24. In one preferred embodiment, a BitBLT engine 34 is provided to facilitate the transfer of image data from one region to another region of the internal memory 24.

Preferably, two data FIFO's or display pipes 26 are provided for transferring the image data from the memory 24 to the graphics display device 14. Particularly, image data is fetched from the storage region 24main and written to a main window pipe 26main, and image data is fetched from the storage region 24sub and written to a sub-window pipe 26sub. Typically, the host 12 provides the main image data, and either the camera 15 or the host 12 provides the sub-window image data, though this is not essential. Additional regions of memory and additional pipes for propagating image data associated with the additional windows may also be provided.

The pipes 26 provide the respective image data to a multiplexer 30 which selects image data from one or the other pipe in response to a control signal S. By selecting one or the other pipe, main window image data may be “overlaid” with sub-window image data. This method requires fetching from the memory 24 and propagating through the pipes 26 all of the image data, even though some main image data will be discarded. The method is therefore not particularly desirable; however, the method is typical and illustrative. It should be understood that the present invention may be used in accordance with any scheme or methodology for increasing the efficiency of data transfer through the system.

The BitBLT engine 34 may be controlled by the host to define a particular window frame corresponding to a particular time. For example, the host 12 may control the BitBLT engine 34 by issuing one or more instructions (hereinafter “an instruction”) to the BitBLT engine 34. Such instructions cause the BitBLT engine 34 to transfer a particular range of image data corresponding to a particular sub-window frame from the internal memory region 24sub to the internal memory region 24main. The range of image data is specified by a corresponding range of addresses of the data in the internal memory 24sub. Similarly, the host 12 may control the multiplexer by issuing it an instruction which causes the multiplexer 30 to select particular image data, corresponding to a particular sub-window frame.

In addition, the graphics controller 10 includes an animate circuit 40 in accordance with the invention, which is adapted to interface with either or both the BitBLT engine 34 and the multiplexer 30, providing animation control. Particularly, the multiplexer 30 and the BitBLT engine 34 provide control for selecting image data as a function of pixel position for a particular window frame. Such “static” control defines a particular window frame in a sequence of window frames defining an animated window. The animate circuit 40 provides “dynamic” control for evolving the animated window over time in a prescribed manner.

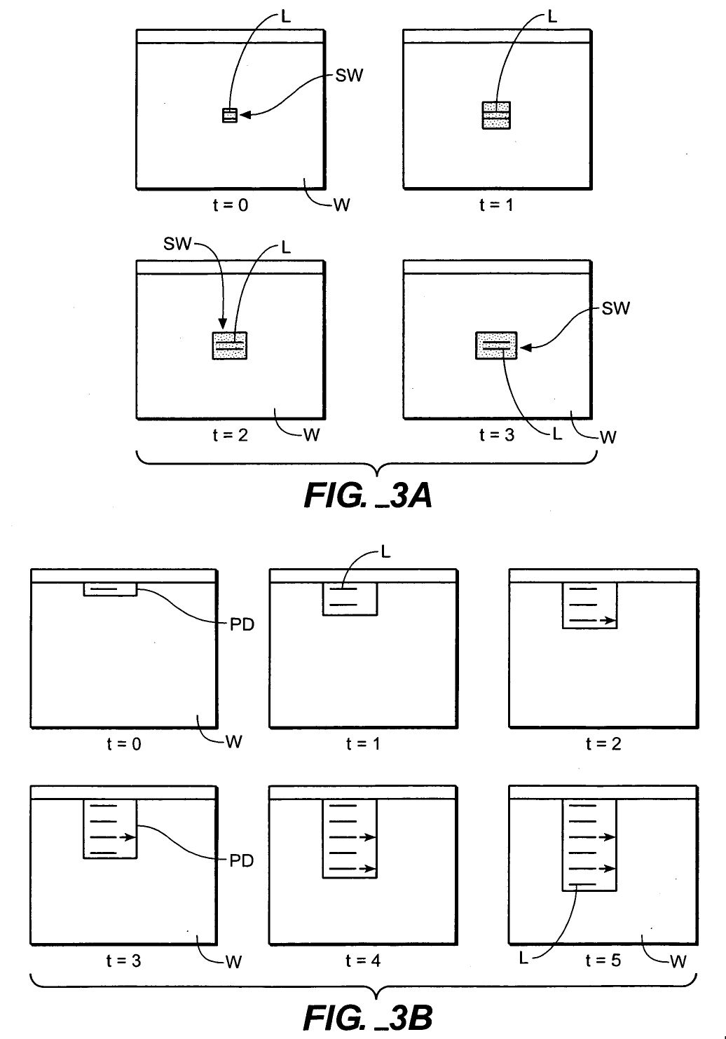

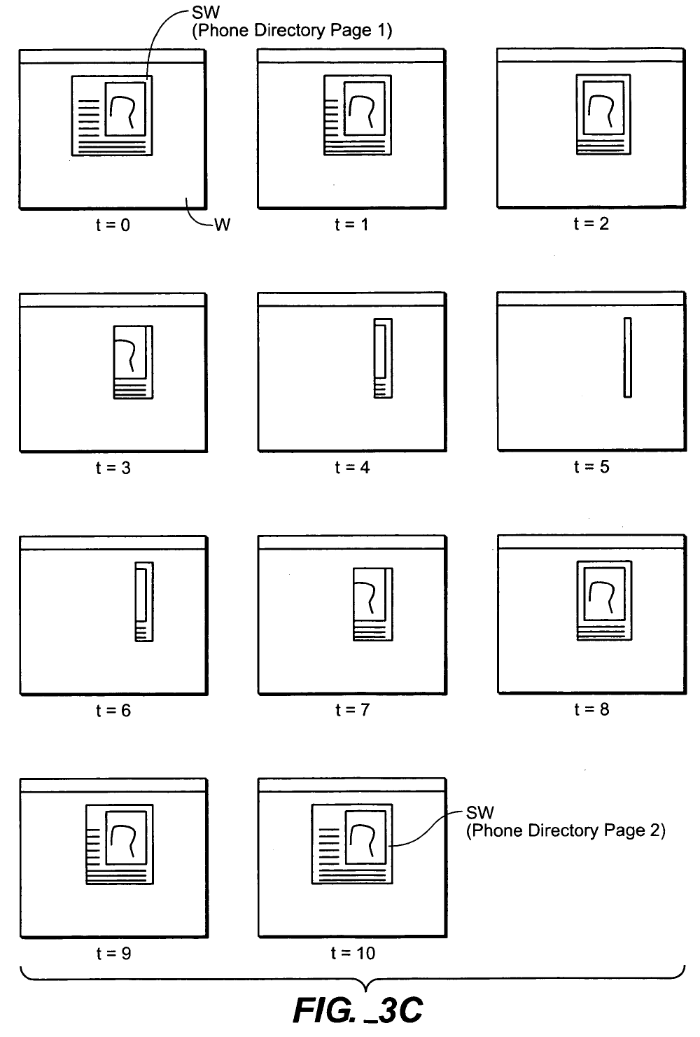

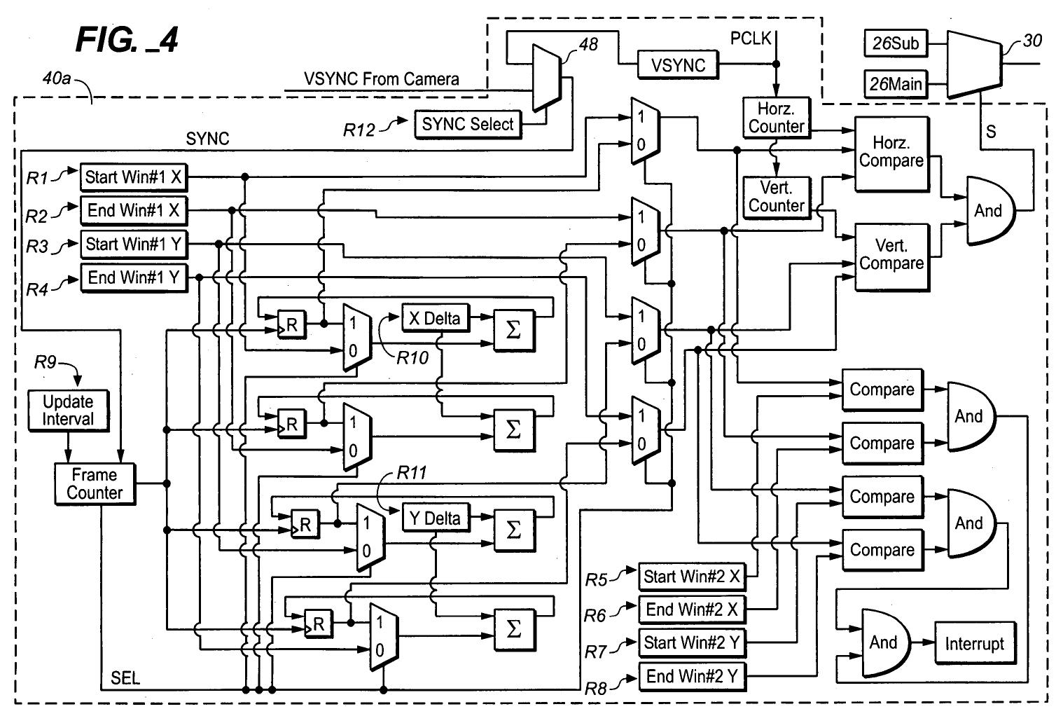

FIGS. 3A-3C show typical examples of the evolution of an animated window over time. Referring to FIG. 3A, a sub-window SW is shown at four times t=0−3. The sub-window overlies a main window W. Two lines L of image data are seen through the sub-window. In this example, the image data remain static as the sub-window grows over time.

FIG. 3B shows a pull-down menu PD at six times t=0−5. The pull-down menu overlies a main window W. Various lines L of information appear as the menu appears to pull down.

FIG. 3C shows a “wiper” transition of a sub-window SW in which a first page, e.g., of a phone directory, is animatedly turned to show a second page over times t=0 to t=10. The sub-window overlies a main Window W.

In general, the evolution of an animated window must be defined in both space and time.

Spatially, a window can be defined by a pair of (x, y) coordinates, one for each of two diagonal corners of the window (assuming the window is static and rectangular). However, an animated window must be spatially defined by all of the window frames of which it is composed. The evolution of the animated window in space is specified by the first and last window frames in the sequence, and by in-between window frames. In the simplest cases, the window grows, shrinks, or translates linearly. Accordingly, in the simplest case of a rectangular window, the evolution of a rectangular window in space can be defined by a pair of (x, y) coordinates for each of the first and last window frames in the sequence. Greater complexity may be provided without departing from the principles of the invention, such as where the window is not rectangular or evolves in a non-linear manner.

Temporally, the evolution of an animated window is defined by specifying the rate of change of the defining spatial coordinates. The rate of change is typically a simple linear velocity (or step-wise or other approximation thereof), but may itself be a function of time. The required information for specifying the evolution of an animated window can be reduced to parameters.

Referring to FIG. 1, the animate circuit 40 includes animation effects registers 42A-42J for receiving representations of parameters for specifying the evolution of an animated window. The host 12 is programmatically or otherwise adapted to instruct the animate circuit 40 by writing the representations into the registers 42. As will be readily appreciated, specifying the evolution of an animated window in time and in space can be accomplished in numerous mathematically equivalent ways.

FIG. 4 shows one preferred animate circuit 40a for animating the window W1 shown in FIG. 2. Referring to FIG. 2, the window W1 comprises a sequence of window frames, each window frame having associated coordinates. Only two of the window frames are shown (in order to not clutter the illustration). The window frame WIN#1 which defines the window WI at an initial time at which animation is commenced, and the window frame WIN#2 (shown in dashed lines) which defines the window W1 at a final time at which animation ceases. In turn, the window frames WIN#1 and WIN#2 are defined by starting and ending values of x and starting and ending values of y, respectively:
START WIN#1 X;
START WIN#1 Y;
END WIN#1 X;
END WIN#1 Y;
START WIN#2 X;
START WIN#2 Y;
END WIN#2 X; and
END WIN#2 Y.
   The window W1 evolves as indicated by the arrows A, which indicate particularly the evolution of corner-most coordinates C of the window frames.

Referring to FIG. 4, the circuit 40a includes registers R1-R11 for storing representations of parameters specifying the evolution of the window W1 in time and space. Registers R1-R8 store representations of the eight spatial parameters indicated immediately above. Registers R9-R11 store representations of temporal parameters. To implement a simple form of temporal evolution, register R9 stores a representation of an “update interval” which defines an increment of time at the end of which a next window frame is produced. Registers R10 and R11 store representations of increments or “deltas” for incrementing (or decrementing) the dimensions of the current window frame to produce the next window frame. Register RIO stores a representation of a delta for incrementing/decrementing in the x dimension and register R11 stores a representation of a delta value for incrementing/decrementing in the y dimension. Preferably, a “SYNC SELECT” register R12 is also provided to select a synchronizing signal for updating the data corresponding to the evolving window frames. The register R12 selects, through the multiplexer 48, a VSYNC signal generated internally to the graphics controller (such as from a panel interface/display module, which is not shown in the figures) or a VSYNC signal provided by the camera. The VSYNC signal from or camera interface. Where image data are provided from the camera, it is advantageous to synchronize to the camera VSYNC signal to prevent “tearing” in the image data caused by reading image data out of the internal memory 24 (FIG. 1) before a full frame of the image data has been provided.

As will be readily appreciated, any of the aforementioned registers can be combined or separated as desired, and as many or as few registers may be provided as is needed to carry out the desired functionality.

The animate circuit 40a is merely exemplary. It should be understood that window evolution can be specified alternatively, windows can be defined alternatively, spatial and temporal changes can be as complex as desired, and while the preferred animate circuit is fully programmable, a lesser degree of programmability may alternatively be provided where, for example, a minimum set of predetermined programs may be selected by the host.

After specifying all the parameters necessary to define the evolution of a window, the host 12 can turn its attention away from the graphics controller 10 toward other tasks, providing an outstanding advantage in reducing host overhead and, therefore, reducing power consumption and increasing speed. In addition, overall performance of the system 8 is improved as the host is not burdened with the requirement of having to respond to time sensitive interrupt requests at the end of each display refresh cycle.

It is to be recognized that, while a particular graphics controller providing for animated windows has been shown and described as preferred, other configurations and methods could be utilized, in addition to those already mentioned, without departing from the principles of the invention. It should be understood that, while preferably implemented in hardware, the animate circuit could be implemented in a combination of hardware and software, or be implemented in software, provided the graphics controller is suitably adapted. For example, a program of instructions stored in a machine readable medium may be provided for execution in a processing device included in the graphics controller. For instance, a graphics controller according an alternative embodiment of the invention may include an embedded processor adapted to execute a program of instructions stored in a memory. For instance, the embedded processor in the graphics controller may execute a program of instructions for performing any of the operations related to receiving an instruction from a host that specifies an evolution of an animated window and automatically animating the window in response to the instruction which have been described in this specification.

The computer systems described in this specification are preferable battery-powered portable computer systems, such as a personal digital assistant or cellular telephone. However, the term “computer system” is used in this specification to broadly refer to any of a wide variety of devices, including but not limited to mainframe, personal, server, and embedded computers.

In this specification the host 12 may be any type of processor or CPU, and the term “host” is used in this specification to broadly refer to any of such processors, CPUs, digital signal processors, or other similar devices. Similarly, the term central processing unit or CPU is considered synonymous with host.

The term “camera” is used in this specification to broadly refer to any of a wide variety of image capture devices, including but not limited to still and video cameras, image scanners, and other similar devices. The term “camera” may also include any source of a digital image, such as a network interface or a JPEG decoder.

The registers for storing representations of various parameters have been shown and described as being separate from the internal graphics controller memory 24. This for clarity of explanation only. It will be appreciated that representations of parameters may be stored in the memory 24 or elsewhere as desired.

As mentioned, the display device 14 is preferably an LCD. The term “display device” is used in this specification to broadly refer to any of a wide variety of devices for rendering images. The term display device is intended to also include hardcopy devices, such as printers and plotters. The term display device additionally refers to all types of display devices, such as CRT, LED, OLED, and plasma, without regard to the particular display technology employed.

The terms and expressions which have been employed in the foregoing specification are used as terms of description and not of limitation, and there is no intention in the use of such terms and expressions to exclude equivalents of the features shown and described or portions thereof, it being recognized that the scope of the invention is defined and limited only by the claims which follow.

1. In a graphics controller for interfacing between a host and a graphics display device, a circuit for receiving an instruction from the host specifying an evolution of an animated window, and for automatically animating said window in response to the instruction.

2. The circuit of claim 1, said window comprising a sequence of window frames, each window frame having associated coordinates defining a corresponding range of image data stored in a memory of the graphics controller, said instruction defining, at least in part, a time rate of change of the coordinates of said window frames.

3. The circuit of claim 2, wherein said instruction passes, from the host to the graphics controller, at least one parameter, the circuit comprising at least one programmable register for receiving said at least one parameter.

4. The circuit of claim 3, wherein said at least one parameter specifies an update interval.

5. The circuit of claim 4, wherein said update interval is temporally established with respect to a synchronizing signal, the circuit comprising at least one programmable register for specifying the source of said synchronizing signal.

6. The circuit of claim 5, further adapted so that the source of said synchronizing signal is selectable between, at least, a VSYNC signal internally generated by the graphics controller and a VSYNC signal from the camera.

7. A system comprising the graphics controller of claim 1, and further comprising:
a host;
a camera;
a memory; and
a graphics display device having an associated display area.

8. The system of claim 7, said window comprising a sequence of window frames, each window frame having associated coordinates defining a corresponding range of image data stored in a memory of said graphics controller, said instruction defining a time rate of change of the coordinates of said window frames.

9. The system of claim 8, further comprising a camera, said graphics controller adapted for interfacing between said camera and said graphics display device.

10. The system of claim 9, adapted to provide for wireless tele-communications.

11. A method for interfacing between a host and a graphics display device having an associated display area, comprising receiving, in a graphics controller separate from the host, an instruction from the host specifying an evolution of an animated window and automatically animating said window in response thereto.

12. The method of claim 11, said window comprising a sequence of window frames, each window frame having associated coordinates defining a corresponding range of image data stored in a memory of the graphics controller, said instruction defining, at least in part, a time rate of change of the coordinates of said window frames.

13. The method of claim 12, further comprising writing, by the host, at least one parameter defined by said instruction into at least one programmable register provided in the graphics controller.

14. The method of claim 13, wherein said at least one parameter specifies an update interval.

15. The method of claim 14, wherein said update interval is temporally established with respect to a synchronizing signal, further comprising writing, by the host, at least one parameter defined by said instruction and defining the source of said synchronizing signal into at least one programmable register provided in the graphics controller.

16. The method of claim 15, further comprising selecting the source of said synchronizing signal between, at least, a VSYNC signal internally generated by the graphics controller and a VSYNC signal from the camera.

17. A medium readable by a machine embodying a program of instructions executable by the machine to perform the method of claim 11.

18. A medium readable by a machine embodying a program of instructions executable by the machine to perform the method of claim 12.
